(19) United States
(12) Patent Application Publication
(10) Pub. No.: US 2003/0212728 A1
(43) Pub. Date: Nov. 13, 2003

(54) Method and system to perform complex number multiplications and calculations

(76) Inventors: Amit Dagan, Shimshit (IL); Gad S. Sheaffer, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/144,538

(22) Filed: May 10, 2002

(51) Int. Cl. G06F 7/52

(52) U.S. Cl. 708/622

(57) ABSTRACT

In a method and apparatus for multiplying a complex number in the form of (a+ib), (±1 ±i) the multiplication result is resolved into addition operations providing the real number component of the multiplication result and the coefficient of i in the multiplication result. The addition operations are formed in a plurality of steps, and the terms a and b are combined in each of a pair of arithmetic units in a plurality of steps to provide the real number component and the complex number coefficient. In the preferred form, the multiplication is performed in four pairs of addition, and an operation code determines the signs of each term in each arithmetic unit in each operation.

### FIELD

An embodiment of this invention relates to the field of computer systems, and more particularly to a method and system for multiplying complex numbers as well as performing other arithmetic operations.

### BACKGROUND

Complex numbers must be handled by computers in many different contexts. For example, in the area of communications, values of complex numbers are processed by algorithms for calculating such functions as Fast Fourier Transforms in processing and correlation of signals in Rake receivers. First and second complex numbers take the form of a+ib and x+iy, where a and b and x and y are real numbers, and the coefficient i is the imaginary number of the square root of minus 1 multiplying these numbers yields the following result:

(a+ib)*(x+iy)=(a*x−b*y)+i(a*y+b*x) (1)

In order to perform this multiplication efficiently on a computer, different ways have been found to resolve the result in equation (1) into sums, differences and multiples of terms in the complex numbers. Different instruction sets have been used to do different methods of calculation to produce the complex number multiplication results. In selecting a particular method, cost versus benefit is always a factor. Parameters to be taken into consideration include the amount of data to be handled and the rate at which it will be provided. In one nominal Rake receiver Design used, For example, in Wideband Code Division Multiplex Access (WCDMA) standard, a Rake receiver may take 2,560 samples of signals and perform the correlation of them 9,000 times per second.

Another example of one of the many applications for multiplication of complex numbers is execution of a Fast Fourier Transform algorithm in a wireless Local Access Network (LAN) operating under the IEEE 802.11a specification (Institute of Electrical and Electronic Engineers, New York, 1999). The 802.11a specification is for operation at 5 GHz. If the number of calculation steps required to perform each multiplication is not minimized, then additional execution cycles are required to perform the calculations. Running additional execution cycles requires running at a higher frequency, and increases total power consumption.

### BRIEF DESCRIPTION OF THE DRAWINGS

Embodiments of the invention are further understood by reference to the following description taken in connection with the following drawings:

FIG. 1 represents one form of a computer system incorporating an embodiment of the present invention;

FIG. 2 illustrates a register file of the processor in the computer system of the embodiment of the FIG. 1;

FIG. 3 is a block diagram of a register structure in which instructions are executed;

FIG. 4 is an illustration of operations performed in the present invention; and

FIG. 5 is a block diagram illustrating the method of the present invention.

### DETAILED DESCRIPTION

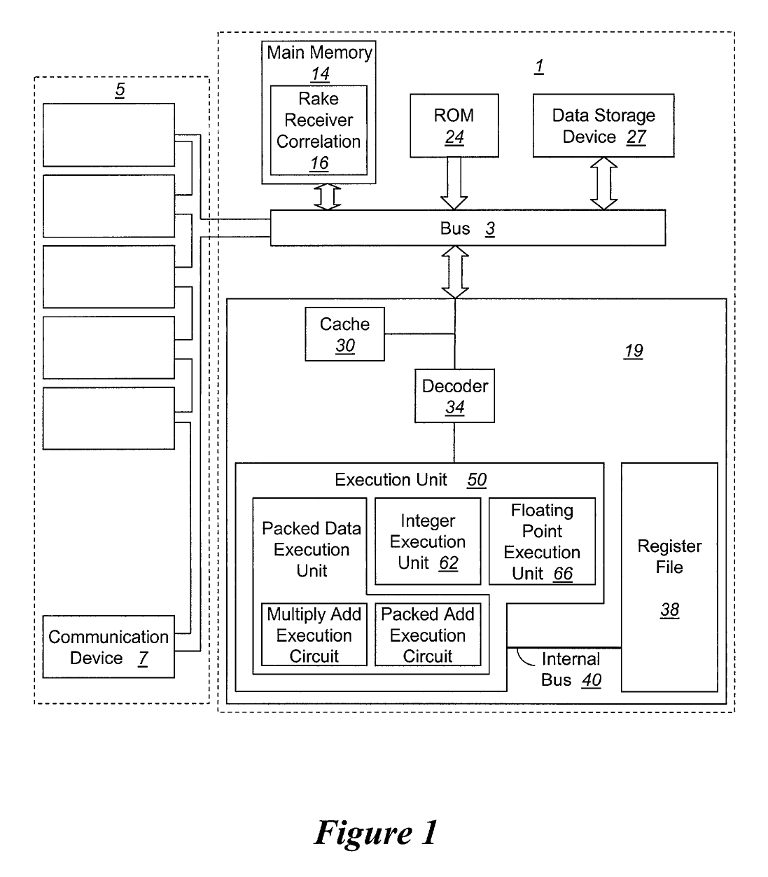

FIG. 1 is a block diagram of a computer system 1. Many different form of computer system 1 may provide the same operation as provided by the particular embodiment of FIG. 1. The computer system 1 communicates via a bus 3 to peripheral devices 5. These devices may include a communications device 7 that could comprise, for example, a Rake receiver.

The computer system 1 comprises a main memory 14. The main memory 14 will normally comprise a random access memory (RAM) or other dynamic storage device. In the illustrated embodiment, in which Rake receiver correlations will be calculated, the main memory 14 includes a Rake receiver correlation program 16. The main memory 14 also stores temporary variables or other information during the execution of instructions by a processor 19. Instructions are embodied in signals. As used in the present description, “instruction” includes control logic as well. The processor 19 and the main memory 14 communicate via the bus 3. A static storage memory 24, preferably comprising a read only memory (ROM) communicates via the bus 3. Also coupled to the bus 3 is a data storage device 27 which stores information and instructions.

The processor 19 includes a cache 30, a decoder 34, an execution unit 36 and a register file 38. The execution unit 36 and register file 38 communicate via an internal bus 40. The register file 38 represents a storage area on the processor 19 for storing information including received data and calculated data. The cache 30 caches data and/or control signals from, for example, the main memory 14. The decoder 34 decodes instructions received by the processor 19 into control signals or microcode entry points. In response to these control signals or microcode entry points, the execution unit 36 performs the called operations. Any system for logically performing instructed operations is comprehended by this description, whether serial or parallel in nature.

The execution unit 36 comprises a data execution unit 50 which includes units for performing selected operations on data. The data may be packed (for example, a 64-bit number may be operated upon into 32-bit units) or unpacked. The execution unit 36 further includes an integer execution unit 62 and a floating point execution unit 66. The integer execution unit executes integer instructions. The floating point execution unit 66 will process the execution of floating point constructions. The computer system 1 may be a terminal in a computer network such as a LAN or a stand-alone PC, for example. In a preferred embodiment, the processor 19 supports an instruction set which is compatible with the Intel architecture instruction set used by existing processors (e.g., the Pentium® Processor manufactured by Intel Corporation of Santa Clara, Calif.). In this embodiment, the processor 19 can support existing Intel architecture. Alternative embodiments may incorporate other instruction sets.

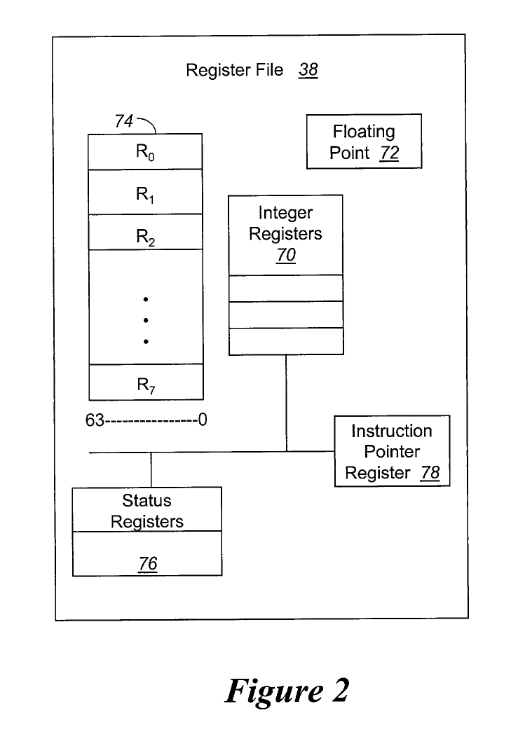

FIG. 2 is a more detailed block diagram of the register file 38 of FIG. 1. The register file 38 stores different types of information. These types of information include control/status information, integer data, floating point data and values being processed. In the present embodiment, the register file 38 includes an integer register 70, a floating point register 72, a data register 74, a status register 76 and an instruction pointer register 78. The processor 19 may operate on packed data. Operations on packed data are well-known. For example, see U.S. Pat. No. 5,936,8722 Ficher, et al., issued Aug. 10, 1999 and entitled “Method and Apparatus for Storing Complex Numbers to Allow for Efficient Complex Multiplication Operations and Performing Such Complex Multiplication Operations.” The processor 19 comprises machine-readable means for performing the method of embodiments of the present invention.

Restating equation (1), multiplication of one complex number by another complex number is of the form:

(a+ib)*(x+iy)=a*x−b*y+i(a*y+b*x) (1)

The values a and x are coefficients of a real component of each complex number, and b and y are coefficients of an imaginary component of each complex number. Execution of the multiplication of equation (1) requires four multiplication operations, namely a*x, b*y, a*y, and b*x. It also requires one addition, a*y+b*x, and one subtraction, a*x−b*y.

In embodiments of the present invention, complex multiplication is performed utilizing the function (±1 ±i). The definition of (±1 ±i) is demonstrated by the relationship:

(a+ib)*(±1 ±i)=a*(±1)−b*(±1)+i(a*(±1)+b*(±1)) (2)

This operation is called DS_ADDSUB, which stands for dual sideways add-subtract instruction. This terminology is used for purposes of present description, but other terminology may be used. The function (±1 ±i) assumes the values (+1, +i), (+1, −i), (−1, +i) and (−1, −i). DS_ADDSUB is embodied selectively as a method, machine-readable medium or processor. A machine-readable medium includes any mechanism that provides (i.e., stores and/or transmits) information in a form readable by a machine (e.g. a computer). For example, a machine-readable medium includes read only memory (ROM); random access memory (RAM); magnetic disk storage media; flash memory devices; electrical, optical, acoustical or other form of propagated signals (e.g., carrier waves, infrared signals, etc.); etc. DS _ADDSUB can be embodied as an instruction including four subinstructions. Each instruction statically defines the type of operation to be performed. Each operation is referred to here as a multiplication opcode. The four opcodes are numbered opcodes 0-3, and are defined and give the results as shown in Table 1.

TABLE 1

| Multiplication opcode | Complex multiply by | The Result |
|---|---|---|
| 0 | (a + ib)*(−1 − i) | (b − a) + i(−a − b) |
| 1 | (a + ib)*(−1 + i) | (−a − b) + i(a−b) |
| 2 | (a + ib)*(1 − i) | (a + b) + i(b − a) |
| 3 | (a + ib)*(1 + i) | (a − b) + i(a + b) |

Alternatively, the DS_ADDSUB instruction provides a selected instruction, and the type of operation to be performed is an immediate value that specifies the type of operation to be performed. In the present description, the DS_ADDSUB instruction, or signals, is described as being provided in a dedicated register. This register need not comprise any particular combination of components, e.g. specific registers in the register file 38. The dedicated register may be embodied in many different ways that are well-known in the art.

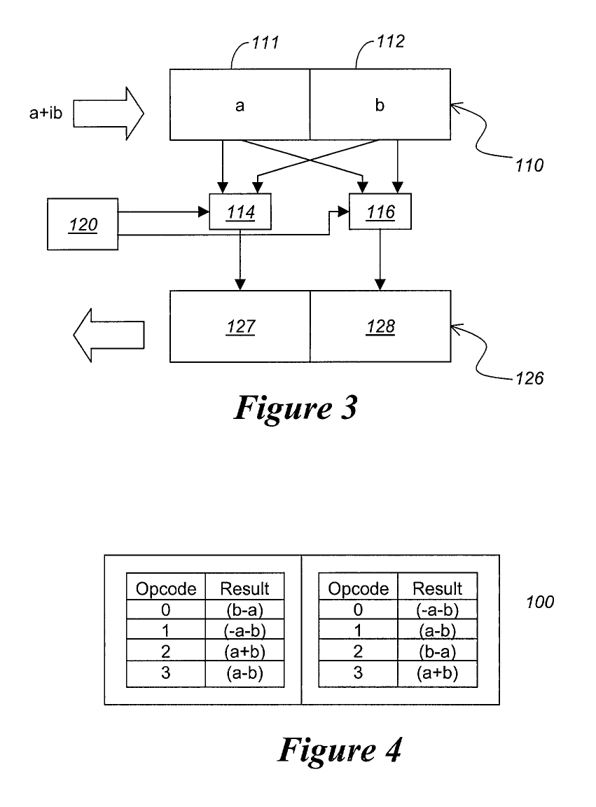

FIG. 3 is an illustration of components in a processor executing the DS_ADDSUB instruction. In the hardware embodiment illustrated in FIG. 3, one DS_ADDSUB instruction is utilized. The type of operation to be performed out of the four operations defining (±1 ±i) is specified implicitly by a special purpose register.

An input complex number register 110 has a first location 111 for storing a real component of a complex number and a second location 112 for storing a coefficient of an imaginary component of a complex number. First and second arithmetic units 114 and 116 each are controlled to translate or negate a value from the locations 111 or 112 as dictated in accordance with the operation specified by each opcode. The arithmetic units 114 and 116 will most conveniently comprise adders, but may take other well-known forms. In the present illustration, inputs and outputs to and from the arithmetic units are controlled by the dedicated register 120. Many well-known alternative forms of connections may be used to provide the outputs as described below and summarized in FIG. 4. The arithmetic units 114 and 116 write to an output complex number register 126. The output complex number register 126 has a first location 127 for storing a real component of a complex number and a second location 128 for storing a coefficient of an imaginary component of a complex of a complex number.

FIG. 4 is a chart illustrating results written to the output complex number register 126 in response to a complex number a+bi in the input complex number register 110. The first column represents numbers written to the real number location 127, and the second column represents numbers written to the second location 128 of the output complex number register 126. In the operations represented by opcodes 0 and 1, the arithmetic unit 114 negates the value in the first, real number location 111 of the input complex number register 110 and writes it to the location 127. In the operations represented by opcodes 2 and 3, the arithmetic unit 114 writes the value from the first location 111 to the first location 127. In the operations represented by opcodes 1 and 3, the arithmetic unit 114 negates the value in the second location 112 of the input complex number register 110 and writes it to the first location 127 of the output complex number register 126. The negated value is added to a current value previously written to the location 127. The result of the addition is written to the location 127 and becomes a new current value. In the operations represented by opcodes 0 and 2, the arithmetic unit 114 reads the value from the second location 112. The value is added to a current value previously written to the location 127. The result of the addition is written to the location 127 and becomes a new current value.

Similarly, in the operations represented by opcodes 0 and 1, the arithmetic unit 116 negates the value in the second, imaginary number location 112 of the input complex number register 110 and writes it to the location 128. In the operations represented by opcodes 2 and 3, the arithmetic unit 116 writes the value from the second location 112 to the first location 128. In the operations represented by opcodes 0 and 2, the arithmetic unit 116 negates the value in the first location 111 of the input complex number register 110. The negated value is added to a current value previously written to the location 128. The result of the addition is written to the location 128 and becomes a new current value. In the operations represented by opcodes 1 and 3, the arithmetic unit 116 reads the value from the first location 111. The value is added to a current value previously written to the location 128. The result of the addition is written to the location 128 and becomes a new current value. While one specific implementation is disclosed above, those skilled in the art will find other ways of implementing the operation defined in Table 1.

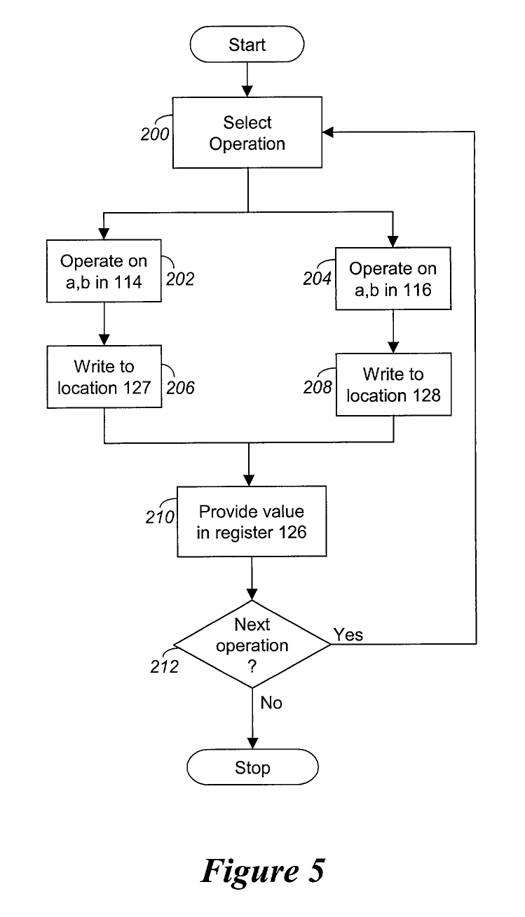

Operation is described with respect to FIG. 5, which is a flow chart. FIG. 5 may also be regarded as illustrating an embodiment in which the arithmetic operations are achieved through “immediate value” processing, i.e. where the type of operation to be performed is on of the input parameters to the operation. At block 200, the dedicated register 120 (illustrated in FIG. 3) provides a current opcode to the adders 114 and 116. In accordance with the opcode, a first addition of a and b is performed at adder 114 and a second addition is performed at adder 116. These operations are shown as being performed in parallel, and illustrated at blocks 202 and 204 respectively. They may as well be performed as sequentially. The results of each adder 114 and 116 are provided to the locations 127 and 128, respectively, as illustrated at block 206 and 208, respectively. The real number component is loaded in location 127 and the imaginary component is loaded in location 128. At block 210, the result of this operation is provided from the register 126. At block 212, it is determined if there is a next operation or a next value to process. If so, operation returns to block 200 where a next operation is selected. If not, operation stops. Opcodes could be processed in parallel as well as in sequence, with further hardware being provided to operate in accordance with the method illustrated in FIG. 5.

One of the many applications for the above form of complex multiplication multiplying by (±1 ±i) is in processing signals in a Rake receiver. WCDMA is one of the standards used in the 3G (third generation) mobile communication protocol. In a Rake receiver, signals that travel from a source to a receiver take a number of different paths to the receiver, for example, in response to reflections. Different signals from the same source must be correlated. The Rake receiver algorithm for WCDMA is used to combine the respective signals of different multi-paths to produce one clear signal strong than the individual components. The Rake receiver performs a “complex correlation operation” defined by the following function:

$${\sum }_{j = 1}^{2560} r [ j ] \times {PN [ j ]}^{*}$$

Where the complex number r[j] is a received sequence and PN[j]* is the conjugate of the psudo-random reference sequence. These expressions have terms with coefficients of (±1 ±i). In a straightforward implementation of the Rake receiver algorithm, a correlation operation is performed using a complex multiply operation for each value of [j]. When using DS_ADDSUB instruction, the actual multiplication is result to the additions and subtractions as articulated, for example, in Table 1 above.

The actual operations performed in the straightforward prior art embodiment, and the embodiment illustrated herein, are described in Table 2.

TABLE 2

| | Correlation phase | Correlation phase |
|---|---|---|
| | without using the | when using the |
| | ds_addsub | ds_addsub |
| | instruction (in | instruction (in |
| | million operations | million operations |
| | per second) | per second) |
| Number of complex | 23 | 0 |
| multiplications (each | | |
| 4 multiplications and | | |
| 2 additions) | | |
| Number of | 46 | 92 |
| additions/subtractions | | |
| (used for accumulation | | |
| (Σ)) | | |
| Total number of real | 92 (=23*4) | 0 |
| multiplications | | |
| Total number of | 92 (=23*2 + 46) | 92 |
| additions/subtractions | | |

Table 2 assumes that the correlation function above is being performed 9,000 times per second. In embodiments of the present invention, the multiplication operations are resolved into the additions and subtractions described above. The straightforward prior art embodiment must perform 92,000,000 real multiplications. Consequently, 92,000,000 multiplications per second are saved through use of the present invention and this example. FIGS. 3 and 4 above are illustrative of the multiplications performed in the calculation to perform the complex correlation operation also.

The above description will enable those skilled in the art to produce many embodiments of the present invention, including the embodiments departing from the specific teachings above to provide embodiments constructed in accordance with the present invention.

What is claimed is:

1. A method comprising:
accessing a value a+ib to multiply the value by (±1, ±i);
producing a first sum of a and b and a second sum of a and b, the sign of a and b in each of said first and second sums being selected in accordance with a pre-selected signal
repeating the operation and producing further pairs of sums of a and b, the sign of a and b in each sum being selected in accordance with further signals;
accumulating a result comprising each first pair comprising a real number portion of a result and each second pair comprising a co-efficient of i; and
and accumulating a result equal to (a*(±1)−b*(±1))+i(a*(±1)+b(±1)).

2. The method according to claim 1 comprising performing said pairs of additions in accordance with four instructions.

3. The method according to claim 2 wherein said signal commands a set of first additions comprising (b−a), (−a−b), (a+b) and (a−b) and wherein said signals command corresponding second addition result of (−a+−b), (a−b), (b−a) and (a+b).

4. The method according to claim 3 comprising performing said additions in a dedicated register, storing a in a first location of an input buffer register and storing b to a second location of said input buffer register;
providing a and b to a first arithmetic unit performing said first addition and providing a and b to a second arithmetic unit to perform said second addition;
providing the output of said first arithmetic unit to a first location of an output buffer register and providing the output of the second arithmetic unit to a second location of the output buffer register and applying an operation code to each said arithmetic unit to determine the signs of a and b in each addition operation.

5. The method of claim 4 further comprising selecting operation codes in sequence from an instruction register.

6. The method of claim 5 further comprising storing said addition results in said output register after each addition to combine them with other addition results defining (a+ib)(±1 ±i).

7. The method according to claim 5 wherein providing the input in the form of a+ib to be multiplied by (±1 ±i) comprises a calculation step in a Rake receiver complex correlation option.

8. The method according to claim 1 comprising accessing from a register in a predetermined order operations each for multiplying by (−1 −i), (−1 +i), (1 −i) and (1 +i).

9. The method according to claim 1 comprising providing in a predetermined order (−1 −i), (−1 +i), (1 −i) and (1 +i) as input parameters.

10. The method according to claim 1 comprising providing both values a and b to first and second arithmetic units and setting the sign of a and b respectively in each operation with said arithmetic unit.

11. The method according to claim 10 said arithmetic units comprise arithmetic units.

12. A machine-readable medium that provides instructions which, when executed by a processor, causes said processor to perform operations comprising accessing a complex number in the form of a+ib to multiply by (±1, ±i)comprising selectively converting said output to the form (b−a)+i(−a−b), (−a−b)+i(a−b), (a+b)+i(b−a), or (a−b)+i(a+b).

13. A machine-readable medium in accordance with claim 12 wherein the instructions cause said processor to perform operations comprising accessing a complex number and producing in response to one instruction a first sum of a and b to comprise a real number and a second sum of a and b to comprise a coefficient of i, the signs of a and b in each addition being set in accordance with an operation code.

14. The machine-readable medium according to claim 12 wherein the instructions cause said processor to perform operations comprising accessing a complex number and producing in response to one instruction a first sum of a and b to comprise a real number and a second sum of a and b to comprise a coefficient of i, the signs of a and b in each addition being set in accordance with a current value of an operation to be performed.

15. The machine-readable medium according to claim 13 wherein said signals cause said processor to perform four pairs of additions and accumulate the result of each addition.

16. The machine-readable medium of claim 13 wherein the instructions causing performance of pairs of addition comprises loading a from a first location of an input buffer register;
loading b from a second location of the input buffer register;
adding a and b in the first arithmetic unit and providing the output of the first arithmetic unit to a first location in an output buffer register;
providing a and b to a second arithmetic unit and providing a result from said second arithmetic unit to a second location of the output buffer register, providing an operation code to the first and second registers for each pair of additions and accumulating each pair of additions from the buffer output register.

17. A machine-readable medium according to claim 16 wherein the instructions cause said processor to multiply a and b by in a predetermined order by (−1 −i), (−1 +i), (1 −i) and (1 +i).

18. The machine-readable medium according to claim 17 wherein the instructions provide a and b to first and second arithmetic units for operations thereon.

19. The machine-readable medium according to claim 16 wherein multiplying a+b by (±1 ±i) comprises a step in a complex correlation operation Rake receiver algorithm.

20. The machine-readable medium according to claim 15 comprising an instruction of providing complex number results to an output register for providing an output to an algorithm utilizing the results of the multiplication.

21. A computer system comprising:
a main memory comprising a program for performance of a routine including multiplication of complex numbers by (±1 ±i) and an execution unit, said memory interacting with said execution unit,
said execution unit comprising a dedicated register, said dedicated register including a complex number buffer register accessing a complex number of the form a+ib and storing a in a first location of an input buffer register and storing b in a second location of said input buffer register;
first and second arithmetic units and an output buffer register;
said first arithmetic unit being coupled to receive a and b from said input buffer register and providing an output to a first location of said second buffer register, said second arithmetic unit being coupled to said second location of the input buffer register and providing an output to a second location of said output buffer register;
an instruction register providing operation codes to said first and second arithmetic units, said operation codes determining the signs of a and b provided by first and second arithmetic units to said first and second locations of said output buffer register respectively.

22. The computer system according to claim 21 further comprising a register for providing in sequence to said first and second arithmetic units operation codes to provide the set of outputs and said first arithmetic unit comprising (b−a), (−a−b), (a+b) and (a−b) and said second arithmetic unit result of (−a−b), (a−b), (b−a) and (a+b), said output buffer means providing values from each pair of multiplication to memory.

23. The computer system of claim 21 wherein the routing comprises in said memory comprises a Rake receiver complex correlation operation routine.

24. The computer system according to claim 22 wherein said operation code register stores four operation codes.

25. A computer system comprising:
a main memory comprising a program for performance of a routine including multiplication of complex numbers by (±1 ±i),
an execution unit to perform said multiplication of complex numbers,
said execution unit comprising first and second arithmetic units being coupled to receive values a and b where a and b are coefficients of a complex number in the form a+ib;
a register to provide signals to multiply a and b in a predetermined order in each of a plurality of operations by (−1 −i), (−1 +i), (1 −i) and (1 +i); and
a register accumulating a result of the form a*(±1)−b*(±1))+i(a*(±1)+b*(±1)).

26. A computer system according to claim 25 wherein said register comprises a dedicated register including a complex number input buffer register accessing a complex number of the form a+ib and storing a in a first location of said input buffer register and storing b in a second location of said input buffer register;
said first and second arithmetic units and an output buffer register;
said first arithmetic unit being coupled to receive a and b from said input buffer register and providing an output to a first location of said second buffer register, said second arithmetic unit being coupled to said second location of the input buffer register and providing an output to a second location of said output buffer register;
and wherein said instruction register is to provide operation codes to said first and second arithmetic units, said operation codes determining the signs of a and b provided by first and second arithmetic units to said first and second locations of said output buffer register respectively.

27. The computer system of claim 26 wherein the routine in said memory comprises a Rake receiver complex correlation operation routine.
